(19) United States
(12) Patent Application Publication
(10) Pub. No.: US 2025/0252437 A1
(43) Pub. Date: Aug. 7, 2025

(54) METHOD AND SYSTEM FOR MONITORING AND VERIFYING SUSTAINABILITY PRACTICES USING A BLOCKCHAIN

(71) Applicant: Mastercard International Incorporated, Purchase, NY (US)

(72) Inventors: Jaipal Singh KUMAWAT, Sikar (IN); Avinash Upadhyay, Noida (IN); Hemant Arora, Pune (IN)

(73) Assignee: Mastercard International Incorporated, Purchase, NY (US)

(21) Appl. No.: 18/435,077

(22) Filed: Feb. 7, 2024

(51) Int. Cl. G06Q 20/40; G06Q 20/36; G06Q 20/38

(52) U.S. Cl. CPC G06Q 20/401; G06Q 20/36; G06Q 20/389

(57) ABSTRACT

A method for monitoring and verifying sustainability practices via blockchain includes: storing, in a blockchain, a smart contract; receiving a data message including a wallet identifier, one or more sustainability metrics, and authentication data; validating the data message using the authentication data; performing a generation process to generate and add a first new block to the blockchain that includes the wallet identifier and the sustainability metrics, wherein the smart contract self-executes upon detecting the wallet identifier and sustainability metrics added to the blockchain, and self-execution of the smart contract comprises the performing of the generation process by the smart contract to add a second new block to the blockchain that includes a verifiable attestation for an entity associated with the wallet identifier indicative that the entity has satisfied one or more sustainability guidelines based on the one or more sustainability metrics.

### FIELD

The present disclosure relates to the monitoring and verification of sustainability practices using a blockchain, specifically the use of a blockchain and third party verification to ensure the performance of sustainability practices and publicly viewable accountability toward sustainability.

### BACKGROUND

As science and technology improve, people have learned more about nature and the effects the human race has had and continue to have on nature. The result is that people know more about both the negative effect that people have had on nature, and how to better serve nature to preserve the world for the current and future generations. This has given rise to the practice of sustainability and the use of environmental, social, and governance (ESG) guidelines to keep people and entities conscious of the needs of people and the world to create a better tomorrow.

However, with all practices and guidelines, enforcement and accountability can be exceedingly difficult to maintain. Some third party entities provide services to certify actions or activities being in accordance with sustainability practices or ESG guidelines. Unfortunately, there are a large number of such entities, resulting in difficulty for participants interested in certification to be able to find such an entity and for parties wishing to identify the practices of a participant to be able to find such information. There is a lack of easily accessible and public information to view practices, guidelines, and certification to encourage participation and to help guide consumers during business interactions. Thus, there is a need for a technological system that can provide for public viewing and accessibility to information regarding sustainability and ESG practices in a way that is easily used while still being secure from tampering and fraud.

### SUMMARY

The present disclosure provides a description of systems and methods for monitoring and verifying sustainability practices via blockchain. A blockchain is used as an immutable form of data storage that can be added to using permissioned entities but publicly accessible. A participating entity that wishes to have their sustainability practices tracked, certified, and publicly available can engage with a platform and agree to achieve specified guidelines. A smart contract is created with the guidelines agreed to by that participant included therein, which is stored on the blockchain available for any consumer to view to be aware of the practices agreed to by the participant. Third party data providers monitor activity by the participant related to the agreed-upon guidelines and generate sustainability metrics for the participant based thereon, which are provided to the blockchain network. The sustainability metrics are added to the blockchain, which can be viewed by consumers to identify the ongoing activity of the participant with respect to reaching their guidelines. When the guidelines are met according to the sustainability metrics, the smart contract self-executes to add a new entry to the blockchain that indicates that the participant has satisfied the applicable guideline(s), providing a publicly accessible certification of the participant's practices. The result is an immutable record of activity by participants and attestation of guideline satisfaction that is readily available for any interested party, providing a process for users and participants that is significantly easier than currently available while also being secure from tampering and fraud.

A method for monitoring and verifying sustainability practices via blockchain includes: storing, in a blockchain, a smart contract; receiving, by a receiver of a blockchain node of a blockchain network associated with the blockchain, a data message from a computing system, the data message including at least a wallet identifier, one or more sustainability metrics, and authentication data; validating, by a processor of the blockchain node, the received data message based on at least the authentication data; and performing, by the blockchain node, a generation process to generate and add a first new block to the blockchain that includes at least the wallet identifier and the one or more sustainability metrics, wherein the smart contract self-executes upon detecting the wallet identifier and the one or more sustainability metrics added to the blockchain, and self-execution of the smart contract comprises the performing of the generation process by the smart contract to add a second new block to the blockchain that includes at least a verifiable attestation for an entity associated with the wallet identifier indicative that the entity has satisfied one or more sustainability guidelines based on the one or more sustainability metrics.

A system for monitoring and verifying sustainability practices via blockchain includes: a computing system; a blockchain network; and a blockchain node included in the blockchain network, wherein the blockchain node stores a blockchain associated with the blockchain network, the blockchain storing at least a smart contract, and includes a receiver receiving a data message from the computing system, the data message including at least a wallet identifier, one or more sustainability metrics, and authentication data, and a processor validating the received data message based on at least the authentication data, the blockchain node performs a generation process to generate and add a first new block to the blockchain that includes at least the wallet identifier and the one or more sustainability metrics, the smart contract self-executes upon detecting the wallet identifier and the one or more sustainability metrics added to the blockchain, and self-execution of the smart contract comprises the performing of the generation process by the smart contract to add a second new block to the blockchain that includes at least a verifiable attestation for an entity associated with the wallet identifier indicative that the entity has satisfied one or more sustainability guidelines based on the one or more sustainability metrics.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for monitoring and verifying sustainability practices via blockchain in accordance with exemplary embodiments.

FIG. 2 is a block diagram illustrating a blockchain node in the system of FIG. 1 for monitoring and verifying sustainability practices via blockchain in accordance with exemplary embodiments.

FIG. 3 is a flow diagram illustrating a process for monitoring and verifying sustainability practices via blockchain in the system of FIG. 1 in accordance with exemplary embodiments.

FIG. 4 is a flow chart illustrating an exemplary method for monitoring and verifying sustainability practices via blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Monitoring and Verification of Sustainability Practices

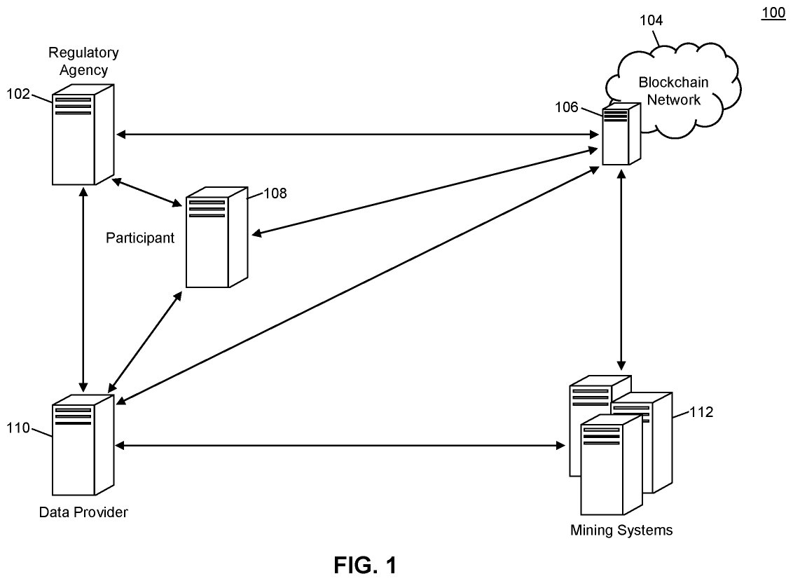

FIG. 1 illustrates a system 100 for the monitoring and verification of sustainability practices in accordance with sustainability guidelines using a blockchain that is immutable and secure while also being publicly viewable to encourage participation and meeting of sustainability guidelines. The system 100 can include one or more regulatory agencies 102, which can be any entity that provides guidelines, regulations, rules, or other criteria to be met regarding sustainability. Regulatory agencies 102 can be governmental agencies, governmental organizations, non-governmental organizations, non-profit groups, efficacy organizations, or any other entity that provides such criteria.

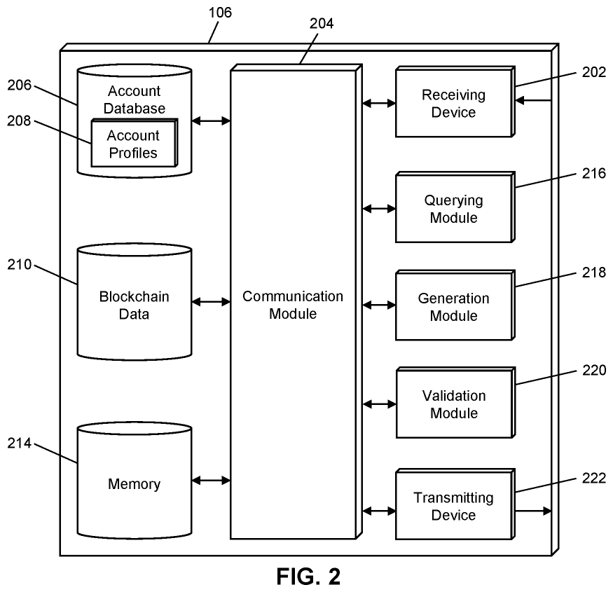

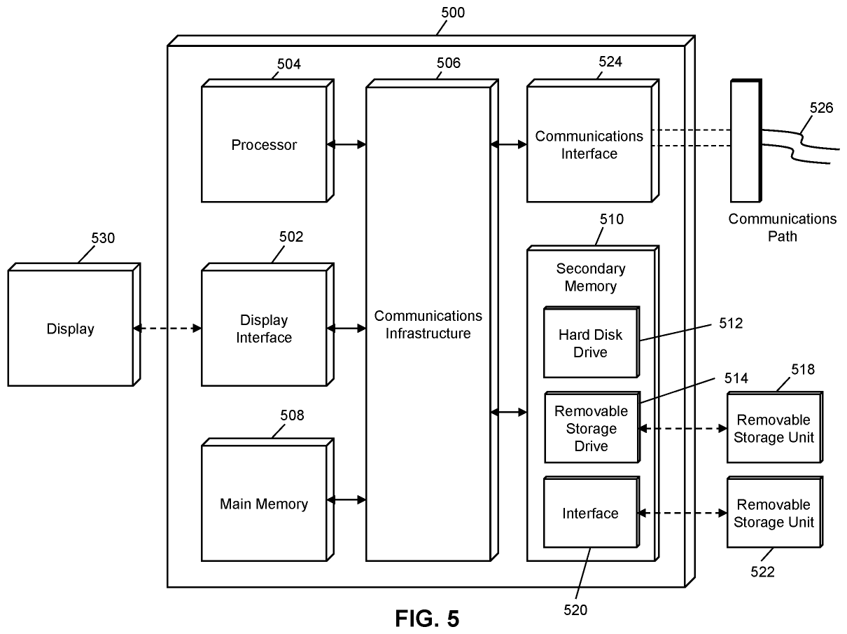

The system 100 can also include a blockchain network 104. The blockchain network 104 can be comprised of a plurality of blockchain nodes 106. Blockchain node 106 can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in the active blockchain nodes 106 in a blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device (e.g., participant 108) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of currency generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

In the system 100, the blockchain can be used to store data regarding the acceptance of, activity related to, and compliance with sustainability guidelines by participants 108. Participants 108 can be individuals, companies, organizations, or other entities that are interested in satisfying sustainability guidelines. As discussed herein, participant 108 can refer to the entity itself as well as computing devices or systems that are operated by or on behalf of the entity.

A participant 108 can be interested in satisfying one or more sustainability guidelines set forth by a regulatory agency 102. Sustainability guidelines can vary based on a number of factors, such as the applicable industry, geographic location, size of the participant 108, business status of the participant 108, time and/or date, etc. As discussed herein, sustainability guidelines can refer to any guidelines related to sustainability, environment, social, and governance (ESG), etc., such as guidelines regarding carbon footprints, carbon emissions, carbon capture, recycling, power usage, power generation, environmental impact, conservation, water usage, water reclamation, etc. The system 100 can be applicable to any type of sustainability guidelines and practices that can be monitored and verified. In some cases, a single blockchain can be used for multiple sustainability guidelines. In other cases, multiple blockchains can be used (e.g., by a single blockchain network 104 or multiple blockchain networks 104), such as blockchains separated by industry, geographic location, etc.

The participant 108 can agree to the one or more sustainability guidelines set forth by the regulatory agency 102. To signify the acceptance, the participant 108 can provide the accepted guidelines to a blockchain node 106 in the blockchain network 104 using a suitable communication network and method. In some cases, the participant 108 can provide the guidelines in a data message that is digitally signed by a private key of a cryptographic key pair (e.g., representing a blockchain wallet of the participant 108 on the blockchain) that can be verified using the corresponding public key of the cryptographic key pair. In other cases, the regulatory agency 102 can provide the guidelines and acceptance by the participant 108 to the blockchain node 106. In either case, the participant 108 and/or regulatory agency 102 can provide a digitally signed verification of the guidelines and their acceptance in addition to the data message such that both entities verify the guidelines and acceptance thereof by the participant 108.

The blockchain node 106 can receive the accepted guidelines and identification of the participant 108 and generate a smart contract. A smart contract is a program that can be stored on a blockchain that is configured to self-execute when one or more conditions are met. The smart contract can monitor the blockchain for such conditions and, when met, can self-execute to perform one or more actions, commonly the addition of one or more new blockchain data entries on the blockchain. In the system 100, the blockchain node 106 can generate a smart contract that is configured to monitor the blockchain for sustainability metrics associated with the participant 108 (e.g., using its public key or other suitable identification value). When such metrics are met, the smart contract can self-execute and generate a new blockchain data entry that is confirmed and added to the blockchain that includes a verifiable attestation that the participant 108 has satisfied the applicable guideline. In some cases, the verifiable attestation can be a certification provided by the regulatory agency 102 that sets forth the satisfied guideline. The verifiable attestation can be viewed on the blockchain by any interested party to learn that the participant 108 has satisfied the applicable sustainability guideline(s).

After the smart contract has been added to the blockchain, the participant 108 can perform activities related to the sustainability guidelines the participant 108 is trying to satisfy. The activities can be any activity that can work towards satisfaction of a sustainability guideline, which can vary as widely as the guidelines themselves. For instance, a participant 108 wanting to meet a sustainability guideline recycling can collect recyclable material and provide such material to an authorized recycler. Such activities can be monitored by one or more data providers 110. Data providers 110 can be participants 108, regulatory agencies 102, or any other entity that can verify activity performed by participants 108 as related to sustainability guidelines. In the above example, the authorized recycler can be the data provider 110, or the data provider 110 can be a non-profit organization that collects data from recyclers regarding the amounts and types of material recycled and the entities that delivered such material. In some cases, a data provider 110 can be provided data by a participant 108 regarding activities thereof, which the data provider 110 can independently verify (e.g., by contacting the authorized recycler). In some instances, a data provider 110 can be instructed by a participant 108 to monitor for activity by that participant 108. In other instances, a data provider 110 can monitor all activity and provide information, as discussed below, to blockchain nodes 106 regardless of entities involved. In some such instances, the data provider 110 can monitor all activity, but may only report such activity to a blockchain node 106 if related to a participant 108 for which a smart contract is stored on the blockchain.

Once a data provider 110 has received data regarding the activity of a participant 108, the data provider 110 can analyze the activity to generate one or more sustainability metrics associated therewith. In some cases, sustainability metrics can be standardized or reformatted activity data. In other cases, sustainability metrics can be metrics that are representative of the guidelines to which they are applicable that are based on the analyzed activity. For instance, in the above example, the participant 108 can agree to recycle 200 tons of material during a calendar year. The activity monitored by the data provider 110 can be the recycling of 26 tons of material. The sustainability metric generated by the data provider 110 can be the number value of the recycled material, the 26 tons, can be a cumulative total of recycled material by the participant 108 during the calendar year, can be a percentage value of the 200 ton sustainability guideline accepted by the participant 108, or other suitable value. In some cases, sustainability metrics used can be specified by the regulatory agency 102 that sets forth the sustainability guidelines to which the metrics are being measured.

Once the data provider 110 has generated the one or more sustainability metrics based on the activity of the participant 108, the data provider 110 can provide the one or more sustainability metrics to a blockchain node 106 in the blockchain network 104. In some cases, the data provider 110 can digitally sign the sustainability metrics to authenticate their accuracy and authenticity, and such that consumers can be sure of the entity that verified the participant's activity for additional transparency. The data provider 110 can also provide the identification of the participant 108 to which the metrics apply, such as by using their public key or other identifying information. In some cases, the participant 108 can also digitally sign the sustainability metrics. The blockchain node 106 can receive the one or more sustainability metrics, verify any digital signatures, and then generate a new blockchain data entry that includes the one or more sustainability metrics and participant 108 identification, which can be included in a new block that is generated, confirmed, and added to the blockchain. The sustainability metrics can then be independently viewed by any entity interested in the sustainability practices of the participant 108.

When the new blockchain data entry with the sustainability metrics is added to the blockchain, the smart contract can identify the addition of the new block and determine if the sustainability guidelines included therein have been met. For instance, in the above example, the smart contract can monitor for a total of 200 tons of a recycled material over the calendar year, monitor for the most recent sustainability metric being at least the 200 tons if the metrics are cumulative, or monitor for the most recent sustainability metric being 100% if the metric is percentage-based. Once the sustainability guideline has been met according to the sustainability metrics added to the blockchain, the smart contract can self-execute to generate a new blockchain data entry that includes a verifiable attestation that the participant 108 has satisfied the sustainability guideline. The attestation can then be viewed by any interested party to identify that the participant 108 successfully met the sustainability guideline, with past blockchain data entries being available to see the progress by the participant 108.

In some embodiments, the self-execution of the smart contact can result in the generation and addition of a new smart contract on the blockchain, in addition to the verifiable attestation. In such embodiments, the new smart contract can be generated by the smart contract itself or by a blockchain node 106, such as based on a notification provided by the smart contract. The new smart contract can continue to monitor the blockchain for sustainability metrics related to the sustainability guideline to identify continued compliance or a failure to meet the sustainability guideline, as applicable. For instance, in the above example, the new smart contract can monitor to see if the participant 108 has failed to keep up with the recycling of 200 tons during a calendar year or has not met the 200 tons after the expiration of another calendar year. In such cases, the new smart contract can self-execute to generate a new blockchain data entry that indicates revocation of the prior attestation of the participant's satisfaction of the sustainability guideline. In some instances, the new smart contract can also be configured to provide a new verifiable attestation if the participant 108 continues to satisfy the sustainability guideline. Such further or ongoing monitoring and actions can be based on the sustainability guidelines.

In some embodiments, the use of sustainability guidelines and metrics can be applicable to the participation and operation of the blockchain itself. Some blockchains can utilize mining systems 112 in the generation of new blocks for the blockchain, where such mining systems 112 can be blockchain nodes 106 or other computing systems that are authorized to perform mining activity to generate values as part of the operation of the blockchain. In traditional blockchains that use mining, the first mining system 112 that satisfies the mining criteria is awarded with an incentive, which can include an amount of cryptographic currency associated with the blockchain. However, as mining can often be resource intensive, and thus at a detriment to sustainability and ESG practices, the system 100 can be used to encourage better sustainability and ESG practices by mining systems 112. In such an embodiment, the mining systems 112 can also participate in the blockchain as participants 108 to try and satisfy sustainability guidelines, such as to offset the resources required for mining. In such cases, mining systems 112 that meet sustainability guidelines, as can be verified via the verifiable attestations on the blockchain, can be provided priority or preference when mining new blocks, such as by being provided additional time to satisfy the mining criteria or being provided less difficult mining criteria. The result is an added incentive to encourage sustainability by mining systems 112, which can also be used to increase the sustainability and good practices by the blockchain network 104 itself in operation of the blockchain.

The systems and methods discussed herein provide for the monitoring and verification of sustainability practices to meet sustainability guidelines using a blockchain. The use of a blockchain can ensure that the data is secure and protected from tampering or fraud, to prevent a participant 108 from falsely claiming or obtaining an attestation regarding sustainability. In addition, because all blocks are stored in the blockchain and viewable, the history of a participant's activity can be readily viewed to provide even further, useful information for interested parties regarding the historical activity of a participant 108 regarding sustainability. The use of data providers 110 for verification of activity and generation of sustainability metrics can ensure that participants 108 cannot take advantage of the system and obtain an attestation without proper performance. The result is a system that is easy for participants 108 and users to use that encourages sustainability in a manner that is easily identifiable and accountable, providing a vast improvement over existing systems.

### Blockchain Nodes

FIG. 2 illustrates an embodiment of a blockchain node 106 of the blockchain network 104 in the system 100 of FIG. 1. It will be apparent to persons having skill in the relevant art that the embodiment of the blockchain node 106 illustrated in FIG. 2 is provided as illustration only and cannot be exhaustive to all possible configurations of the blockchain node 106 suitable for performing the functions as discussed herein. For example, the computer system 500 illustrated in FIG. 5 and discussed in more detail below can be a suitable configuration of the blockchain node 106.

The blockchain node 106 can include a receiving device 202. The receiving device 202 can be configured to receive data over one or more networks via one or more network protocols. In some instances, the receiving device 202 can be configured to receive data from regulatory agencies 102, other blockchain nodes 106, participants 108, data providers 110, mining systems 112, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by regulatory agencies 102 and/or participants 108 that can be superimposed or otherwise encoded with sustainability guidelines, acceptance to sustainability guidelines, digital signatures, identification information, public keys, etc. The receiving device 202 can also be configured to receive data signals electronically transmitted by other blockchain nodes 106, which can be superimposed or otherwise encoded with, public keys, configuration keys, configuration key requests, request for identification data, blockchain data entries, blocks, confirmation messages, etc. The receiving device 202 can also be configured to receive data signals electronically transmitted by data providers 110 that can be superimposed or otherwise encoded with sustainability metrics, digital signatures, public keys, identification information, etc.

The blockchain node 106 can also include a communication module 204. The communication module 204 can be configured to transmit data between modules, engines, databases, memories, and other components of the blockchain node 106 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the blockchain node 106 and external components of the blockchain node 106, such as externally connected databases, display devices, input devices, etc. The blockchain node 106 can also include a processing device. The processing device can be configured to perform the functions of the blockchain node 106 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The blockchain node 106 can also include an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a participant 108, such as to store public keys, smart contract data, sustainability activity data, etc.

The blockchain node 106 can also include blockchain data 210, which can be stored in a memory 214 of the regulatory agency processing server 102 or stored in a separate area within the blockchain node 106 or accessible thereby. The blockchain data 210 can include a blockchain, which may be comprised of a plurality of blocks and be associated with the blockchain network 104 and a blockchain. In some cases, the blockchain data 210 can further include any other data associated with the blockchain and management and performance thereof, such as block generation algorithms, digital signature generation and confirmation algorithms, communication data for blockchain nodes 106, smart contracts, cryptographic keys, etc.

The blockchain node 106 can also include a memory 214. The memory 214 can be configured to store data for use by the blockchain node 106 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the blockchain node 106 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, configuration keys, cryptographic keys including public keys and/or private keys, communication data, blockchain algorithms and data, encryption algorithms, sustainability guidelines, sustainability activity data, sustainability metrics, etc.

The blockchain node 106 can include a querying module 216. The querying module 216 can be configured to execute queries on databases to identify information. The querying module 216 can receive one or more data values or query strings and can execute a query string based thereon on an indicated database, such as the blockchain data 210 of the blockchain node 106 to identify information stored therein. The querying module 216 can then output the identified information to an appropriate engine or module of the blockchain node 106 as necessary or appropriate. The querying module 216 can, for example, execute a query on the account database 206 to identify an account profile 208 related to received sustainability metrics to identify the public key associated with a participant 108 based on identification information for the participant 108 received from a data provider 110.

The blockchain node 106 can also include a generation module 218. The generation module 218 can be configured to generate data for use by the blockchain node 106 in performing the functions discussed herein. The generation module 218 can receive instructions as input, can generate data based on the instructions, and can output the generated data to one or more modules of the blockchain node 106. For example, the generation module 218 can be configured to generate blockchain data entries, blocks, encryption keys, device profiles, request messages, configuration keys, smart contracts, etc.

The blockchain node 106 can also include a validation module 220. The validation module 220 can be configured to perform data validations and verifications for the blockchain node 106 as part of the functions discussed herein. The validation module 220 can receive instructions as input, can perform data validations or verification as instructed, and can output a result of the data validations or verifications to one or more modules of the blockchain node 106. In some cases, the input can include the data to be validated or verified and/or data to be used in the validation or verification. In other cases, the validation module 220 can be configured to identify such data, such as in the account database 206 and/or memory 214. The validation module 220 can be configured to, for example, validate new blockchain data entries and/or blocks, verify digital signatures, validate sustainability metrics, verify successful encryptions, verify configuration key or cryptographic key authenticity, etc.

The blockchain node 106 can also include a transmitting device 222. The transmitting device 222 can be configured to transmit data over one or more networks via one or more network protocols. In some instances, the transmitting device 222 can be configured to transmit data to regulatory agencies 102, other blockchain nodes 106, participants 108, data providers 110, mining systems 112, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to regulatory agencies 102 and/or participants 108 that can be superimposed or otherwise encoded with requests for digital signatures, requests for identification information, requests for sustainability guideline data, verifiable attestations, sustainability metrics, etc. The transmitting device 222 can also be configured to electronically transmit data signals to other blockchain nodes 106, which can be superimposed or otherwise encoded with converted device profiles, public key requests, configuration keys, configuration key requests, identification data for computing devices, device profile requests, blockchain data entries, blocks, confirmation messages, etc. The transmitting device 222 can also be configured to electronically transmit data signals to data providers 110 that can be superimposed or otherwise encoded with requests for digital signatures, requests for sustainability metrics, sustainability activity data, requests for participant identification information, etc.

### Process for Monitoring and Verification of Sustainability Practices

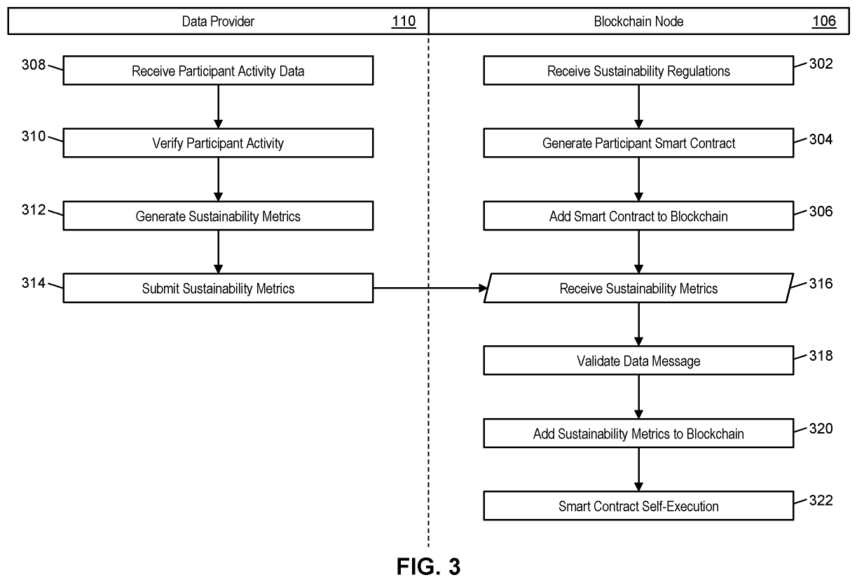

FIG. 3 illustrates a process in the system 100 of FIG. 1 for the acceptance of sustainability practices by a participant 108, the monitoring and verification of activity related to those practices, and the generation and storage of a verifiable attestation regarding satisfaction of sustainability guidelines on a public blockchain.

In step 302, the receiving device 202 of a blockchain node 106 in the blockchain network 104 in the system 100 of FIG. 1 can receive a plurality of sustainability regulations that are applicable to a participant 108, such as can be provided by a regulatory agency 102. In some cases, the received sustainability regulations can be regulations agreed to by the participant 108, such as can be indicated by the inclusion of a digital signature generated by the participant 108. In such cases, the validation module 220 of the blockchain node 106 can verify the included digital signature to authenticate the acceptance by the participant 108.

In step 304, the generation module 218 of the blockchain node 106 can generate a new smart contract. The smart contract can be configured to monitor for sustainability metrics added to the blockchain that are associated with the participant 108 regarding satisfaction of the accepted sustainability regulations. The smart contract can be further configured to self-execute to generate a verifiable attestation from the regulatory agency 102 to be added to the blockchain once the sustainability guidelines are satisfied. In step 306, the smart contract can be added to the blockchain by the blockchain node 106, such as by the generation (e.g., via the generation module 218) of a new blockchain data entry that includes the new smart contract that is included in a new block generated by blockchain node 106 that is transmitted (e.g., via the transmitting device 222) to other blockchain nodes 106 in the blockchain network 104 and confirmed by a majority thereof.

As part of the process, in step 308, a data provider 110 can receive activity data regarding the sustainability guidelines from the participant 108. The activity data can be based on the sustainability guidelines and can be associated with one or more activities performed by the participant 108 that can be used to judge satisfaction of the accepted sustainability guidelines. In step 310, the data provider 110 can verify that the associated activities were performed by the participant 108 and the accuracy of the received activity data and can make any adjustments to the activity data as necessary or appropriate. In step 312, the data provider 110 can generate one or more sustainability metrics based on the activity data, where the one or more sustainability metrics are metrics related to the satisfaction of the accepted sustainability guidelines. In step 314, the data provider 110 can submit the one or more sustainability metrics, along with identification of the participant 108, to the blockchain node 106 using a suitable communication network and method. In some cases, the data provider 110 can also digitally sign the submission and/or include a digital signature of the participant 108 regarding accuracy of the one or more sustainability metrics.

In step 316, the receiving device 202 of the blockchain node 106 can receive the one or more sustainability metrics and participant identification from the data provider 110. In step 318, the validation module 220 of the blockchain node 106 can validate the received data message that includes the one or more sustainability metrics and the identification of the participant 108. Validation of the data message can include the verification of any digital signatures on the message or included therein, as well as the verification and/or authentication of any other data. In step 320, the blockchain node 106 can add the one or more sustainability metrics to the blockchain by including the one or more sustainability metrics and participant identification in a new blockchain data entry that is generated by the generation module 218 of the blockchain node 106, included in a new block generated by the generation module 218 of the blockchain node 106, and confirmed by a majority of other blockchain nodes 106 in the blockchain network 104.

In step 322, the smart contract stored on the blockchain can monitor for the addition of the new blockchain data entry that includes the one or more sustainability metrics. The smart contract can identify the one or more sustainability metrics and determine that the accepted sustainability guidelines have been met based on the one or more sustainability metrics. Upon a successful determination, the smart contract can self-execute, which can generate a new blockchain data entry that includes a verifiable attestation by the regulatory agency 102 that the participant 108 has satisfied the accepted sustainability guidelines, which is then added to the blockchain using the methods discussed above.

### Exemplary Method for Monitoring and Verification of Sustainability Via Blockchain

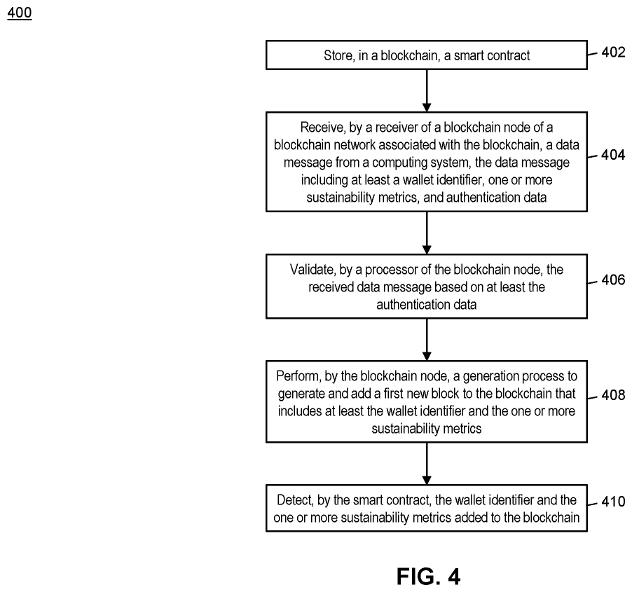

FIG. 4 illustrates a method 400 for the monitoring and verification of sustainability practices via the use of a publicly accessible blockchain.

In step 402, a smart contract can be stored in a blockchain. In step 404, a receiver (e.g., receiving device 202) of a blockchain node (e.g., blockchain node 106) of a blockchain network (e.g., blockchain network 104) associated with the blockchain can receive a data message from a computing system (e.g., data provider 110), the data message including at least a wallet identifier, one or more sustainability metrics, and authentication data. In step 406, a processor (e.g., validation module 220) of the blockchain node 106 can validate the received data message based on at least the authentication data.

In step 408, a generation process can be performed (e.g., via the generation module 218) by the blockchain node to add a first new block to the blockchain that includes at least the wallet identifier and the one or more sustainability metrics. In step 410, the wallet identifier and one or more sustainability metrics added to the blockchain can be detected by the smart contract. As a result of the detection of the wallet identifier and one or more sustainability metrics, the smart contract can self-execute, where self-execution of the smart contract comprises the performing of the generation process by the smart contract to add a second new block to the blockchain that includes at least a verifiable attestation for an entity (e.g., participant 108) associated with the wallet identifier indicative that the entity has satisfied one or more sustainability guidelines based on the one or more sustainability metrics.

In one embodiment, detecting the wallet identifier and the one or more sustainability metrics added to the blockchain can include detecting that the one or more sustainability metrics exceeds one or more corresponding threshold values. In some embodiments, the one or more sustainability guidelines can include at least one of: environmental guidelines, social guidelines, governance guidelines, carbon footprint guidelines, carbon emission guidelines, recycling guidelines, and power usage guidelines. In one embodiment, the generation process can include: generating a blockchain data entry that includes one or more data values; generating a block that includes at least the generated blockchain data entry; transmitting the generated block to a plurality of additional blockchain nodes in the blockchain network; receiving, from a majority of the plurality of additional blockchain nodes, a confirmation message for the generated block; and storing, in the blockchain, the generated block.

In some embodiments, the generation process can comprise selecting a mining node of a plurality of mining nodes (e.g., mining systems 112) to perform a mining operation for a new block for the blockchain. In a further embodiment, the mining node can be selected from the plurality of mining nodes based on at least the storage of one or more attestations in the blockchain associated with the mining node. In one embodiment, the blockchain node can be selected from a plurality of blockchain nodes based on at least the storage of one or more attestations in the blockchain associated with the blockchain node. In some embodiments, the wallet identifier can be a public key of a cryptographic key pair.

### Computer System Architecture

FIG. 5 illustrates a computer system 500 in which embodiments of the present disclosure, or portions thereof, can be implemented as computer-readable code. For example, the regulatory agency 102, blockchain nodes 106, participant 108, data provider 110, and mining systems 112 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for monitoring and verifying sustainability practices via blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for monitoring and verifying sustainability practices via blockchain, comprising:
storing, in a blockchain, a smart contract;
receiving, by a receiver of a blockchain node of a blockchain network associated with the blockchain, a data message from a computing system, the data message including at least a wallet identifier, one or more sustainability metrics, and authentication data;
validating, by a processor of the blockchain node, the received data message based on at least the authentication data; and
performing, by the blockchain node, a generation process to generate and add a first new block to the blockchain that includes at least the wallet identifier and the one or more sustainability metrics, wherein
the smart contract self-executes upon detecting the wallet identifier and the one or more sustainability metrics added to the blockchain, and
self-execution of the smart contract comprises the performing of the generation process by the smart contract to add a second new block to the blockchain that includes at least a verifiable attestation for an entity associated with the wallet identifier indicative that the entity has satisfied one or more sustainability guidelines based on the one or more sustainability metrics.

2. The method of claim 1, wherein detecting the wallet identifier and the one or more sustainability metrics added to the blockchain includes detecting that the one or more sustainability metrics exceeds one or more corresponding threshold values.

3. The method of claim 1, wherein the one or more sustainability guidelines include at least one of: environmental guidelines, social guidelines, governance guidelines, carbon footprint guidelines, carbon emission guidelines, recycling guidelines, and power usage guidelines.

4. The method of claim 1, wherein the generation process comprises:
generating a blockchain data entry that includes one or more data values;
generating a block that includes at least the generated blockchain data entry;
transmitting the generated block to a plurality of additional blockchain nodes in the blockchain network;
receiving, from a majority of the plurality of additional blockchain nodes, a confirmation message for the generated block; and
storing, in the blockchain, the generated block.

5. The method of claim 1, wherein the generation process comprises selecting a mining node of a plurality of mining nodes to perform a mining operation for a new block for the blockchain.

6. The method of claim 5, wherein the mining node is selected from the plurality of mining nodes based on at least storage of one or more attestations in the blockchain associated with the mining node.

7. The method of claim 1, wherein the blockchain node is selected from a plurality of blockchain nodes based on at least storage of one or more attestations in the blockchain associated with the blockchain node.

8. The method of claim 1, wherein the wallet identifier is a public key of a cryptographic key pair.

9. A system for monitoring and verifying sustainability practices via blockchain, comprising:
a computing system;
a blockchain network; and
a blockchain node included in the blockchain network, wherein
the blockchain node stores a blockchain associated with the blockchain network, the blockchain storing at least a smart contract, and includes
a receiver receiving a data message from the computing system, the data message including at least a wallet identifier, one or more sustainability metrics, and authentication data, and
a processor validating the received data message based on at least the authentication data,
the blockchain node performs a generation process to generate and add a first new block to the blockchain that includes at least the wallet identifier and the one or more sustainability metrics,
the smart contract self-executes upon detecting the wallet identifier and the one or more sustainability metrics added to the blockchain, and
self-execution of the smart contract comprises the performing of the generation process by the smart contract to add a second new block to the blockchain that includes at least a verifiable attestation for an entity associated with the wallet identifier indicative that the entity has satisfied one or more sustainability guidelines based on the one or more sustainability metrics.

10. The system of claim 9, wherein detecting the wallet identifier and the one or more sustainability metrics added to the blockchain includes detecting that the one or more sustainability metrics exceeds one or more corresponding threshold values.

11. The system of claim 9, wherein the one or more sustainability guidelines include at least one of: environmental guidelines, social guidelines, governance guidelines, carbon footprint guidelines, carbon emission guidelines, recycling guidelines, and power usage guidelines.

12. The system of claim 9, wherein the generation process comprises:
generating a blockchain data entry that includes one or more data values;
generating a block that includes at least the generated blockchain data entry;
transmitting the generated block to a plurality of additional blockchain nodes in the blockchain network;
receiving, from a majority of the plurality of additional blockchain nodes, a confirmation message for the generated block; and
storing, in the blockchain, the generated block.

13. The system of claim 9, wherein the generation process comprises selecting a mining node of a plurality of mining nodes to perform a mining operation for a new block for the blockchain.

14. The system of claim 13, wherein the mining node is selected from the plurality of mining nodes based on at least storage of one or more attestations in the blockchain associated with the mining node.

15. The system of claim 9, wherein the blockchain node is selected from a plurality of blockchain nodes based on at least storage of one or more attestations in the blockchain associated with the blockchain node.

16. The system of claim 9, wherein the wallet identifier is a public key of a cryptographic key pair.
